(19) United States
(12) Patent Application Publication
(10) Pub. No.: US 2024/0270298 A1
(43) Pub. Date: Aug. 15, 2024

(54) GATHERING-TYPE FOLDING CART FRAME

(71) Applicant: Ningbo Matrix Trading Co.,Ltd, Ningbo (CN)

(72) Inventors: Libo Song, Ningbo (CN); Wenjie Wang, Ningbo (CN); Zhengming He, Ningbo (CN)

(21) Appl. No.: 18/434,790

(22) Filed: Feb. 6, 2024

(30) Foreign Application Priority Data
Feb. 15, 2023 (CN) 2023101148128
Dec. 29, 2023 (CN) 2023236400872

(51) Int. Cl. B62B 3/00; B62B 3/02; B62B 5/06

(52) U.S. Cl. CPC B62B 3/007; B62B 3/025; B62B 5/067; B62B 2205/06

(57) ABSTRACT

A gathering-type folding cart frame comprises a plurality of support mechanisms and corresponding wheels arranged under the support mechanisms, a central folding mechanism is arranged between the support mechanisms, enclosure folding mechanisms are arranged on the cart frame, and a handle is arranged on one side of the cart frame in the direction of travel; after the central folding mechanism is folded, the support mechanisms gather towards the central folding mechanism. The invention adopts a gathering-type folding method, and can be folded in the length direction and width direction at the same time after folding, the folding method is simple, easy to use, the folded volume is small, there is no sharp angle structure, and there is no safety hazard. The invention is provided with enclosures on the top of the cart frame, which can improve the strength of the top of the cart frame.

### 1. TECHNICAL FIELD

The invention relates to the technical field of folding carts, in particular to a gathering-type folding cart frame.

### 2. BACKGROUND ART

Folding vehicles are commonly used tools for carrying goods, camping, etc.

In traditional technology, most folding vehicles adopt a flat-folding structure, which results in the fact that the folding vehicle can only be folded in the length direction and cannot be folded in the width direction; it still has a large volume after folding, making it inconvenient to store; and it cannot effectively pull, fold and store the basket cloth when folded.

CN210478734U discloses a folding cart that can be folded in the length direction and width direction at the same time, but it has the following problems: 1. this scheme provides folding mechanisms in the length and width directions at the same time, resulting in the use of more hinges and connecting rods; therefore, it is heavy and difficult to carry; in addition, since the failures of the folding cart often occur at the hinges, more hinges may easily cause the overall service life of the folding cart to be reduced; 2. the load carried by this scheme is concentrated on the central connector in the middle, but the central connector and the connecting rods connected to it adopt straight rods, resulting in insufficient overall support and excessive stress at the central connector, which is prone to damage or deformation; 3. after this scheme is folded, many sharp-angled structures are formed at the hinges, which poses safety risks and may cause accidental injuries.

Therefore, a kind of gathering-type folding cart frame has become an urgent problem to be solved.

### 3. SUMMARY OF THE INVENTION

The object of the invention is to overcome the above technical defects, and provide a gathering-type folding cart frame. In order to realize the above objects, the invention provides the following technical scheme: a gathering-type folding cart frame comprises a plurality of support mechanisms and corresponding wheels arranged under the support mechanisms, a central folding mechanism is arranged between the support mechanisms, enclosure folding mechanisms are arranged on the cart frame, and a handle is arranged on one side of the cart frame in the direction of travel;
after the central folding mechanism is folded, the support mechanisms gather towards the central folding mechanism.

As an improvement, the central folding mechanism comprises a central connector and connecting rods, one end of the connecting rods is hinged with the central connector, and the other end is hinged with the support mechanism;
the central connector comprises a first central connector located above and a second central connector located below; the connecting rods hinged with the first central connector are marked as first connecting rods, the connecting rods hinged with the second central connector are marked as second connecting rods; the first connecting rods and the second connecting rods at corresponding positions are arranged cross in X shapes and are hinged to each other in the middle section.

As an improvement, the support mechanisms are vertical poles, the vertical poles are provided with a fixed connector that are fixedly connected to the vertical poles and sliding connectors that slide along the vertical poles; the ends of the first connecting rods are hinged with the fixed connectors; the ends of the second connecting rods are hinged with the sliding connectors.

As an improvement, the enclosure folding mechanism is composed of two cross-arranged and hinged third connecting rods, both ends of the third connecting rods are respectively hinged with the fixed connectors and the sliding connectors on the opposite side support mechanisms.

As an improvement, the connecting rods and the third connecting rods adopt a three-section bending design; the connecting rods form an arched structure near the central connector.

As an improvement, fixing parts of a tarpaulin are arranged on the top of the vertical poles; the bottom of the handle is provided with two side support rods hinged with the vertical rods.

As an improvement, the support mechanism comprises an inner support rod and an outer support rod, the inner support rod and the outer support rod are spaced apart and fixedly connected through fixing members; the inner support rod and the outer support rod are provided with a first sliding block and a second sliding block, the first sliding block and the second sliding block slide along the inner support rod and the outer support rod respectively, the second sliding block is L-shaped, and is set in a staggered position with the first sliding block at an inner right angle, so that the first sliding block and the second sliding block can slide without interfering with each other.

As an improvement, the ends of the first connecting rods are hinged with the fixing members; the ends of the second connecting rods are hinged with the first sliding blocks.

As an improvement, the enclosure folding mechanism is composed of two fourth connecting rods and two fifth connecting rods, the two fourth connecting rods are hinged at the end and are respectively hinged with the second sliding blocks on the same side; the two fifth connecting rods are hinged at the end and are respectively hinged with the fixing members on the same side; the fourth connecting rods and the fifth connecting rods on the same side are arranged cross in X shapes and are hinged to each other in the middle section.

As an improvement, the cart frame is provided with a basket cloth, the four corners of the top of the basket cloth are respectively fixedly connected to the four fixing members at the top; the four corners of the bottom of the basket cloth are respectively fixedly connected to the four first sliding blocks, the center position of the bottom of the basket cloth is fixedly connected to the first central connector.

Compared with the prior art, the advantages of the invention are as follows:
1. the invention adopts a gathering-type folding method, and can be folded in the length direction and width direction at the same time after folding, the folding method is simple, easy to use, the folded volume is small, there is no sharp angle structure, and there is no safety hazard;
2. the connecting rods of the invention adopt the three-section bending design and form an arch structure at the central folding mechanism, which has good bearing capacity and system stability;
3. the invention is provided with enclosures on the top of the cart frame, which can improve the strength of the top of the cart frame, improve the strength and durability of the opening position of the basket, and increase the service life of the folding carts;
4. during the folding process of the invention, the folding mechanism can pull and fold the basket cloth, and while folding the cart frame, the basket cloth can also be folded and stored. The invention is easy to use and simple to operate, making it easy to use during outings or camping.

### 4. BRIEF DESCRIPTION OF ACCOMPANY DRAWINGS

FIG. 1 is a schematic diagram of the structure of Embodiment 1 of the invention.

FIG. 2 is a schematic diagram of the structure of the central folding mechanism in Embodiment 1 of the invention.

FIG. 3 is a schematic diagram of the structure of the enclosure folding mechanisms and the handle in Embodiment 1 of the invention.

FIG. 4 is a schematic diagram of the structure of Embodiment 1 of the invention when it is in a gathered state.

FIG. 5 is a schematic diagram of the structure of Embodiment 2 of the invention.

FIG. 6 is a schematic diagram of the structure of Embodiment 2 of the invention after removing the basket cloth.

FIG. 7 is a schematic diagram of the structure of the support mechanisms in Embodiment 2 of the invention.

FIG. 8 is a schematic diagram of the structure of the inner support rod and the outer support rod in Embodiment 2 of the invention.

FIG. 9 is a schematic diagram of the structure of the central folding mechanism in Embodiment 2 of the invention.

FIG. 10 is a schematic diagram of the structure of the enclosure folding mechanisms in Embodiment 2 of the invention.

As shown in the figures: 1 support mechanism, 2 wheel, 3 central folding mechanism, 4 enclosure folding mechanism, 5 handle, 6 central connector, 7 connecting rod, 8 first central connector, 9 second central connector, 10 first connecting rod, 11 second connecting rod, 12 vertical pole, 13 fixed connector, 14 sliding connector, 15 third connecting rod, 16 fixing part of a tarpaulin, 17 side support rod, 18 inner support rod, 19 outer support rod, 20 fixing member, 21 first sliding block, 22 second sliding block, 23 fourth connecting rod, 24 fifth connecting rod, 25 basket cloth.

### 5. SPECIFIC EMBODIMENT OF THE INVENTION

In order to make the objects, technical schemes and advantages of the embodiments of the invention clearer, the technical schemes in the embodiments of the invention will be clearly and completely described below in combination with the accompanying drawings in the embodiments of the invention, obviously, the described embodiments are some, but not all embodiments of the invention. The components of the embodiments of the invention generally described and illustrated in the drawings herein may be arranged and designed in a variety of different configurations.

In the description of the invention, it should be understood that the orientation or positional relationship indicated by the terms “center”, “upper”, “lower”, “left”, “right”, “vertical”, “horizontal”, “inner”, “outer” and so on are based on the orientation or positional relationship shown in the accompanying drawings, or the orientation or positional relationship that product of the invention is usually placed in when it is used, only for the convenience of describing the invention and simplifying the description, rather than indicating or implying that the indicated device or element must have a specific orientation, as well as a specific orientation structure and operation, therefore, it should not be construed as a limitation of the invention. In addition, the terms of “first”, “second”, “third” and so on are only used to differentiate the description, and should not be construed as indicating or implying relative importance.

In addition, if the terms “horizontal”, “vertical”, “overhanging” and other terms appear, it does not mean that the component is required to be absolutely horizontal or overhanging, but can be slightly inclined. For example, “horizontal” simply means that its direction is more horizontal than “vertical”, it does not mean that the structure must be completely horizontal, but can be slightly inclined.

In the description of the invention, “a plurality of” means at least two.

In the description of the invention, it should also be noted that the terms of “arrange”, “install”, “link”, “connect”, etc., should be generally understood unless there are specific restrictions or stipulations, for example, the “connect” may refer to fixed connection, detachable connection or integral connection; the “connect” may also refer to mechanical connection or electrical connection; the means of “connect” may be directly connected or indirectly connected through an intermediate medium, and may be internal communication between the two elements. For those skilled in the art, the specific meaning of the above terms in the invention can be understood according to the specific situation.

The following is a further detailed description of a gathering-type folding cart frame of the invention in combination with the accompanying drawings.

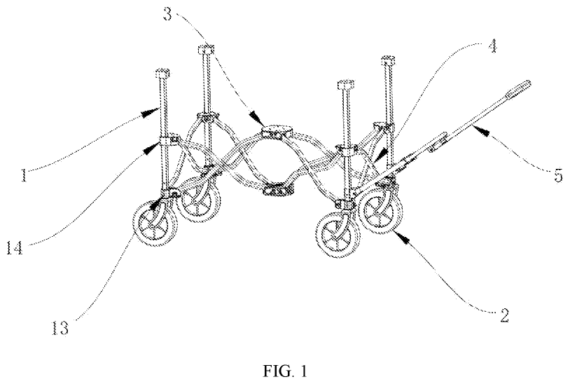

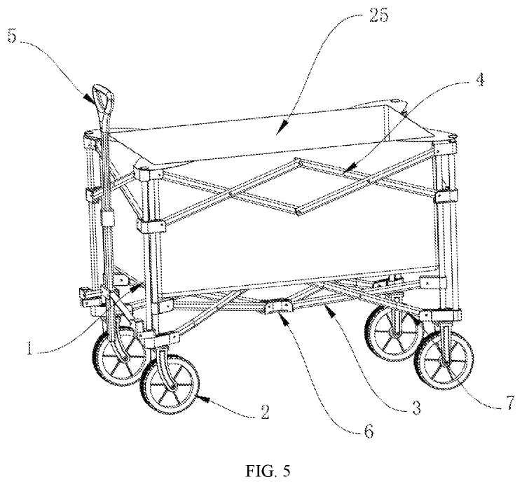

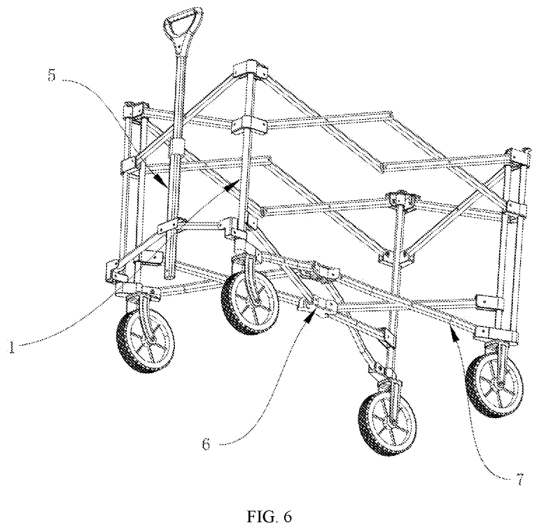

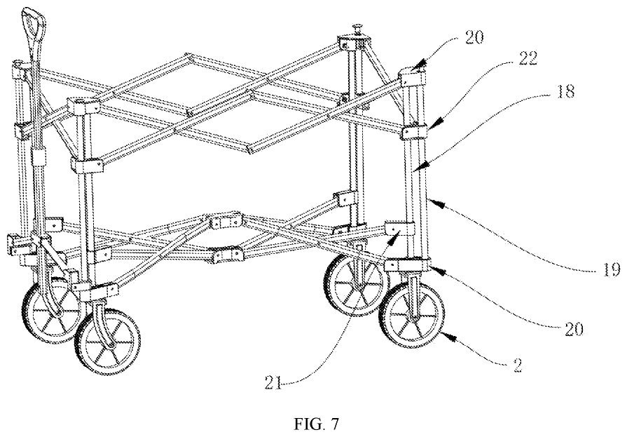

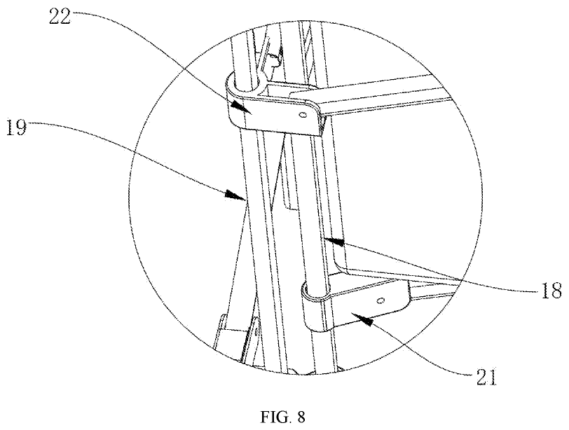

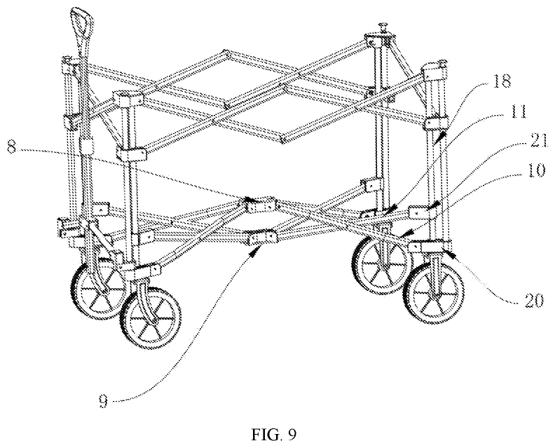

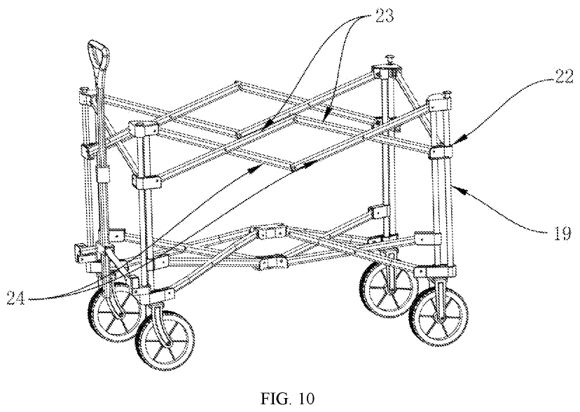

Combined with FIG. 1-10, the specific implementation process of a gathering-type folding cart frame of the invention is as follow:

### Embodiment 1

This embodiment provides a gathering-type folding cart frame, the cart frame comprises a plurality of support mechanisms 1 and corresponding wheels 2 arranged under the support mechanisms 1, a central folding mechanism 3 is arranged between the support mechanisms 1, enclosure folding mechanisms 4 are also arranged on the cart frame, and a handle 5 is arranged on one side of the cart frame in the direction of travel.

After the central folding mechanism 3 is folded, the support mechanisms 1 gather towards the central folding mechanism 3.

In this embodiment, the support mechanisms 1 are vertical poles 12, the vertical poles 12 are provided with a fixed connector 13 that are fixedly connected to the vertical poles 12 and sliding connectors 14 that slide along the vertical poles 12.

The central folding mechanism 3 comprises a central connector 6 and connecting rods 7, one end of the connecting rods 7 is hinged with the central connector 6, and the other end is hinged with the fixed connectors 13 or the sliding connectors 14.

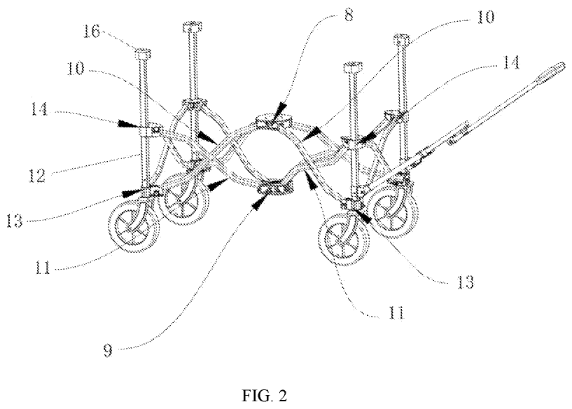

As shown in FIG. 2, the central connector 6 comprises a first central connector 8 located above and a second central connector 9 located below. The connecting rods 7 hinged with the first central connector 8 are marked as first connecting rods 10, the ends of the first connecting rods 10 are hinged with the fixed connectors 13. The connecting rods 7 hinged with the second central connector 9 are marked as second connecting rods 11, the ends of the second connecting rods 11 are hinged with the sliding connectors 14. The first connecting rods 10 and the second connecting rods 11 at corresponding positions are arranged cross in X shapes and are hinged to each other in the middle section.

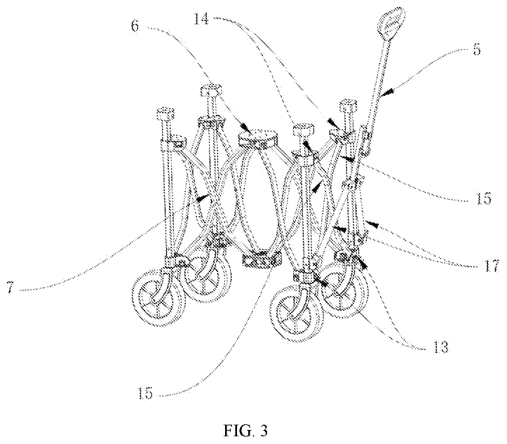

As shown in FIG. 3, the enclosure folding mechanism 4 is composed of two cross-arranged and hinged third connecting rods 15, both ends of the third connecting rods 15 are respectively hinged with the fixed connectors 13 and the sliding connectors 14 on the opposite side support mechanisms 1.

The connecting rods 7 and the third connecting rods 15 adopt a three-section bending design, and have an arc transition at the bending point. The connecting rods 7 form an arched structure near the central connector 6.

Fixing parts of a tarpaulin 16 are arranged on the top of the vertical poles 12. The bottom of the handle 5 is provided with two side support rods 17 hinged with the vertical rods 12.

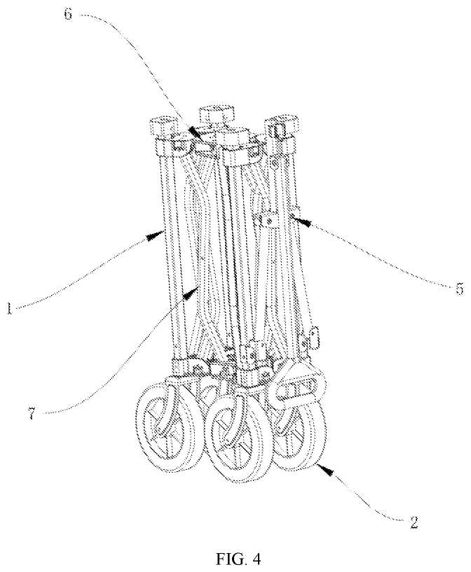

FIG. 4 is a structural diagram of the cart frame in a folded state. It can be seen from the figure that the cart frame can be folded in the length direction and width direction at the same time; the folding method is simple, easy to use, and the cart frame has a small volume after being folded, does not have any sharp corners, so there is no safety hazard.

### Embodiment 2

This embodiment provides a gathering-type folding cart frame, the cart frame comprises support mechanisms 1, a central folding mechanism 3 and enclosure folding mechanisms 4, the support mechanisms 1 are the support rods located at the four corners of the cart frame, wheels 2 are arranged under the support rods, a central folding mechanism 3 is arranged between the support mechanisms 1.

The support mechanism 1 comprises an inner support rod 18 and an outer support rod 19, the inner support rod 18 and the outer support rod 19 are spaced apart and fixedly connected through fixing members 20; the inner support rod 18 and the outer support rod 19 are provided with a first sliding block 21 and a second sliding block 22, the first sliding block 21 and the second sliding block 22 slide along the inner support rod 18 and the outer support rod 19 respectively, the second sliding block 22 is L-shaped, and is set in a staggered position with the first sliding block 21 at an inner right angle, so that the first sliding block 21 and the second sliding block 22 can slide without interfering with each other.

The central folding mechanism 3 is located at the bottom of the cart frame, and is connected to the support mechanisms 1 through the fixing members at the bottom and the first sliding block 21. After the central folding mechanism 3 is folded, the supporting mechanisms 1 gather toward the central folding mechanism 3.

The central folding mechanism 3 comprises a central connector 6 and connecting rods 7, one end of the connecting rods 7 is hinged with the central connector 6, and the other end is hinged with the fixing members 20 or the first sliding blocks 21.

The central connector 6 comprises a first central connector 8 located above and a second central connector 9 located below.

The connecting rods 7 hinged with the first central connector 8 are marked as first connecting rods 10, the ends of the first connecting rods 10 are hinged with the fixing members 20;
the connecting rods 7 hinged with the second central connector 9 are marked as second connecting rods 11, the ends of the second connecting rods 11 are hinged with the first sliding blocks 21;
the first connecting rods 10 and the second connecting rods 11 at corresponding positions are arranged cross in X shapes and are hinged to each other in the middle section.

The enclosure folding mechanisms 4 are located above the sides of the cart frame, the enclosure folding mechanisms 4 are connected to the support mechanisms 1 through the fixing members 20 at the top and the second sliding blocks 22.

The enclosure folding mechanism 4 is composed of two fourth connecting rods 23 and two fifth connecting rods 24, the two fourth connecting rods 23 are hinged at the end and are respectively hinged with the second sliding blocks 22 on the same side; the two fifth connecting rods 24 are hinged at the end and are respectively hinged with the fixing members 20 on the same side.

The fourth connecting rods 23 and the fifth connecting rods 24 on the same side are arranged cross in X shapes and are hinged to each other in the middle section.

The cart frame is provided with a basket cloth 25, the four corners of the top of the basket cloth 25 are respectively fixedly connected to the four fixing members 20 at the top; the four corners of the bottom of the basket cloth 25 are respectively fixedly connected to the four first sliding blocks 21, the center position of the bottom of the basket cloth 25 is fixedly connected to the first central connector 8.

A folding handle 5 is arranged on one side of the cart frame.

The invention and its embodiments have been described above, this description is not restrictive, and what is shown in the accompanying drawing is only one of the embodiments of the invention, and the actual structure is not limited to this. All in all, if those skilled in the art receives its enlightenment, without deviating from the object of the invention, and without creatively designing structures and embodiments similar to the technical scheme of the invention shall fall within the protection scope of the invention.

1. A gathering-type folding cart frame comprises a plurality of support mechanisms and corresponding wheels arranged under the support mechanisms, a central folding mechanism is arranged between the support mechanisms, enclosure folding mechanisms are arranged on the cart frame, and a handle is arranged on one side of the cart frame in the direction of travel;
after the central folding mechanism is folded, the support mechanisms gather towards the central folding mechanism.

2. A gathering-type folding cart frame of claim 1, the central folding mechanism comprises a central connector and connecting rods, one end of the connecting rods is hinged with the central connector, and the other end is hinged with the support mechanism;
the central connector comprises a first central connector located above and a second central connector located below; the connecting rods hinged with the first central connector are marked as first connecting rods, the connecting rods hinged with the second central connector are marked as second connecting rods; the first connecting rods and the second connecting rods at corresponding positions are arranged cross in X shapes and are hinged to each other in the middle section.

3. A gathering-type folding cart frame of claim 2, the support mechanisms are vertical poles, the vertical poles are provided with a fixed connector that are fixedly connected to the vertical poles and sliding connectors that slide along the vertical poles; the ends of the first connecting rods are hinged with the fixed connectors; the ends of the second connecting rods are hinged with the sliding connectors.

4. A gathering-type folding cart frame of claim 3, the enclosure folding mechanism is composed of two cross-arranged and hinged third connecting rods, both ends of the third connecting rods are respectively hinged with the fixed connectors and the sliding connectors on the opposite side support mechanisms.

5. A gathering-type folding cart frame of claim 4, the connecting rods and the third connecting rods adopt a three-section bending design; the connecting rods form an arched structure near the central connector.

6. A gathering-type folding cart frame of claim 5, fixing parts of a tarpaulin are arranged on the top of the vertical poles; the bottom of the handle is provided with two side support rods hinged with the vertical rods.

7. A gathering-type folding cart frame of claim 2, the support mechanism comprises an inner support rod and an outer support rod, the inner support rod and the outer support rod are spaced apart and fixedly connected through fixing members; the inner support rod and the outer support rod are provided with a first sliding block and a second sliding block, the first sliding block and the second sliding block slide along the inner support rod and the outer support rod respectively, the second sliding block is L-shaped, and is set in a staggered position with the first sliding block at an inner right angle, so that the first sliding block and the second sliding block can slide without interfering with each other.

8. A gathering-type folding cart frame of claim 7, the ends of the first connecting rods are hinged with the fixing members; the ends of the second connecting rods are hinged with the first sliding blocks.

9. A gathering-type folding cart frame of claim 8, the enclosure folding mechanism is composed of two fourth connecting rods and two fifth connecting rods, the two fourth connecting rods are hinged at the end and are respectively hinged with the second sliding blocks on the same side; the two fifth connecting rods are hinged at the end and are respectively hinged with the fixing members on the same side; the fourth connecting rods and the fifth connecting rods on the same side are arranged cross in X shapes and are hinged to each other in the middle section.

10. A gathering-type folding cart frame of claim 9, the cart frame is provided with a basket cloth, the four corners of the top of the basket cloth are respectively fixedly connected to the four fixing members at the top; the four corners of the bottom of the basket cloth are respectively fixedly connected to the four first sliding blocks, the center position of the bottom of the basket cloth is fixedly connected to the first central connector.
